(19) United States
(12) Patent Application Publication
(10) Pub. No.: US 2004/0230013 A1
(43) Pub. Date: Nov. 18, 2004

(54) Blends of poly (alpha-methylene-gamma-methyl-gamma-butyrolactone-co-glycidyl methacrylate) and polyphenylene sulfide polymer, articles therefrom and preparation thereof

(76) Inventors: Charles J. Brandenburg, Newark, DE (US); David M. Dean, West Chester, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/766,346

(22) Filed: Jan. 28, 2004

Related U.S. Application Data
(60) Provisional application No. 60/444,352, filed on Jan. 31, 2003.

(51) Int. Cl. C08L 81/02

(52) U.S. Cl. 525/537

(57) ABSTRACT

This invention discloses blends of copolymeric compositions with repeat units of glycidyl methacrylate and alpha-methylene-gamma-methyl-gamma-butyrolactone with polyphenylene sulfide (PPS). This invention further discloses a process for improving mechanical properties of PPS.

This application claims the benefit of U.S. Provisional Application No. 60/444,352, filed Jan. 31, 2003.

### FIELD OF INVENTION

This invention relates to blends of copolymeric compositions with repeat units of glycidyl methacrylate and alpha-methylene-gamma-methyl-gamma-butyrolactone with polyphenylene sulfide (PPS). This invention further relates to a process for improving mechanical properties of polymers comprising PPS. This invention also relates to shaped articles made therefrom.

### BACKGROUND

This invention relates to a polymer composition comprising a polyphenylene sulfide (hereinafter PPS) and at least one such copolymer of alpha-methylene lactone/glycidyl methacrylate (hereinafter alpha-ML/GMA), wherein the glycidyl methacrylate (hereinafter GMA) repeat units act as a reactive compatibilizer between the PPS and the alpha-methylene lactone (hereinafter alpha-ML) copolymer.

U.S. Pat. No. 4,871,810 discloses thermoplastic compositions that demonstrate high temperature resistance properties comprising for example PPS and ethylene copolymers. U.S. Pat. Nos. 5,625,002 and 5,654,358 describe a PPS composition comprising an epoxy-group containing olefinic polymer and an elastomer based on polyamide. The purpose of the blend is to provide improved impact resistance, moldability and flowability.

Polymer blending is a very attractive method for obtaining new materials with synergistic physical properties; however, most polymer blends are incompatible and require a compatibilizer to obtain desirable physical properties. For example, the compatibilizer either interact chemically with both phases or have a specific interaction with one phase and physical interaction with the other (Tedesco, et al., Polymer Testing, 21, 11-15 (2002)). For example, addition of an appropriate graft or a block copolymer reduces the interfacial tension between the two incompatible phases and increases the surface area of the dispersed phase such that adhesion is promoted in the binary system and the morphology of the dispersed phase is stabilized.

The invention of the present application relates to compositions and methods of making polymeric blends of PPS and alpha-MUGMA copolymers to give desirable physical properties.

Blends derived from alpha-ML/GMA copolymers and PPS have outstanding physical properties. Shaped, extruded and molded articles made from such blends have applications in markets such as automotive parts, electrical connectors, consumer and industrial products.

### SUMMARY OF INVENTION

The present invention relates to new copolymer compositions comprising PPS and methods for making the same. Accordingly, in one embodiment the invention provides a copolymer composition comprising:

(a) at least one polymeric repeat unit represented by formula I derived from alpha-methylene lactone monomer,

(b) at least one polymeric repeat unit represented by formula 11 derived from glycidyl methacrylate monomer, wherein said polymeric repeat unit represented by formula 11 comprises from about 0.5% to about 45% by weight of the copolymer composition;

(c) polyphenylene sulfide according to formula (III), and

(d) optionally, one or more impact modifier in the range from 0.5% to 35% by total weight of all compounds,

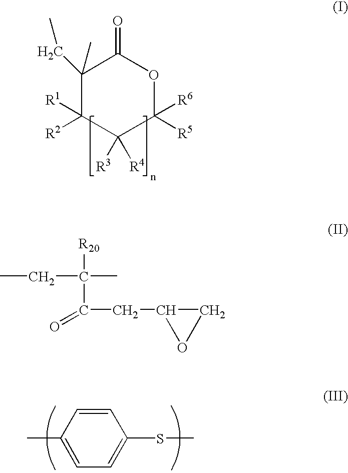

wherein: n is 0, 1 or 2;

R¹, R², R³, R⁴, R⁵, R⁶, and R₂₀ are independently hydrogen, a functional group, hydrocarbyl or substituted hydrocarbyl,

In another aspect the invention provides a method for preparing a copolymer composition, the method comprising the steps of:

(a) contacting at least one alpha methylene lactone monomer of formula (I) with a glycidyl methacrylate monomer of general formula (II), in an aqueous medium,

(b) optionally, contacting the product of step (a) with a chain-transfer agent and a surfactant,

(c) contacting the product of step (a) or step (b) with an initiator,

(d) contacting the product of step (c) with a coagulant, to obtain the copolymer composition,

(e) optionally, contacting the product of step (d) with ethyl acetate,

(f) optionally, agitating the product of step (e),

(g) optionally, filtering the copolymer composition, and

(h) optionally, drying the copolymer composition.

In a preferred embodiment the invention provides a shaped, molded or extruded article comprising the copolymer compositions of the invention.

### DETAILED DESCRIPTION OF THE INVENTION

The terms used in the present invention are defined below.

A “hydrocarbyl group” is a univalent group containing only carbon and hydrogen. If not otherwise stated, it is preferred that hydrocarbyl groups (and alkyl groups) herein contain 1 to about 30 carbon atoms.

By “substituted hydrocarbyl” herein is meant a hydrocarbyl group, which contains one or more substituent groups, which are inert under the process conditions to which the compound containing these groups is subjected. The substituent groups also do not substantially interfere with the process. If not otherwise stated, it is preferred that substituted hydrocarbyl groups herein contain 1 to about 30 carbon atoms. Included in the meaning of “substituted” are heteroaromatic rings. In substituted hydrocarbyl, all of the hydrogens may be substituted, as in trifluoromethyl.

By “functional group” it is meant a group other than hydrocarbyl or substituted hydrocarbyl, which is inert under the process conditions to which the compound or polymer containing the group is subjected. Functional groups do not substantially interfere with any process described herein that the compound or polymer in which they are present may take part in. Examples of functional groups include halo (fluoro, chloro, bromo and iodo), ether such as -OR22 wherein R22 is hydrocarbyl or substituted hydrocarbyl.

By “reactive functional group” it is meant a functional group that may react with another functional group present in the process or composition. By “may react” it is meant that the functional group may react with its counterpart reactive group, but it is not necessary that such reaction happen or that all of the reactive functional groups react with one another. Usually in the formation of the compositions described herein some fraction of these reactive functional groups will react.

By “copolymerizable under free radical conditions” it is meant that the (potential) monomers, preferably vinyl monomers, are known to copolymerize under free radical polymerization conditions. The free radicals may be generated by any of the usual processes, for example, thermally, from radical initiators such as peroxides or azonitriles, by UV-radiation, using appropriate sensitizers, etc., and by ionizing radiation. These polymers may be prepared by various types of processes, such as continuous, batch, and semibatch, which are well known in the art. Many combinations of free radically copolymerizable monomers are known, see for instance, J. Brandrup, et al., Ed., Polymer Handbook, 4^{th} Ed., John Wiley & Sons, New York, 1999, p. II/181-II/308.

By “batch emulsion polymerization” it is meant that all ingredients, including monomers, surfactants, and chain transfer agents, are added at the beginning of the polymerization. The polymerization begins as soon as initiator is added.

By “semi-continuous emulsion polymerization” it is meant that one or more of the ingredients is added continuously or in incremental amounts. The monomers may be added in pure form or as pre-made emulsions. The advantages over a batch process are better control over heat of reaction, particle number, colloidal stability, coagulum formation, and particle morphology.

By “continuous emulsion polymerization” is meant that one or more ingredients is fed continuously to a polymerization tank or series of tanks and the polymer product (latex) is continuously removed at the same rate. By “low-temperature emulsion polymerization” is meant that emulsion polymerization reaction is carried out with a redox-type initiator.

The first step in the process is to prepare the alpha-ML/GMA copolymer via, preferably, emulsion polymerization. The second step is to coagulate the alpha-MBL/GMA emulsion using a standard coagulating agent such as, for example, magnesium sulfate. This affords a slurry of very fine polymer particles. The third step is to add an organic solvent, preferably ethyl acetate, to the particle slurry with vigorous stirring. This causes the polymer slurry to agglomerate into polymer beads with uniform size. These polymer beads are very easy to filter and wash. In addition, they are very easy to work with in an extrusion and blending process. The polymer beads can be easily mixed and fed along with standard pellets of engineering resins such as nylon and polyester. If ethyl acetate is not used, the resulting polymer is a very fine powder, which can create problems of contamination and handling.

In the first step of the process of the invention, a copolymer comprising alpha-methylene lactone- and glycidyl methacrylate-based repeat units is prepared by an emulsion polymerization process. The copolymer is comprised of repeat units derived from the monomer represented by formula (I) and the monomer represented by formula (II) below

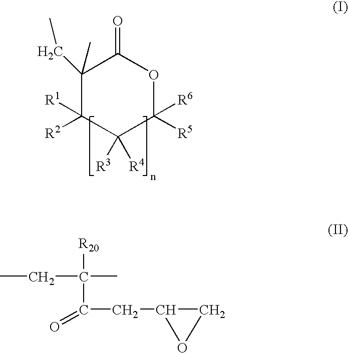

wherein: n is 0, 1 or 2;

R¹, R², R³, R⁴, R⁵, R⁶, and R₂₀ are independently, hydrogen, a functional group, hydrocarbyl or substituted hydrocarbyl;

In one embodiment of composition of the invention, said copolymers can be blended with thermoplastic polyphenylene sulfide (PPS) matrix resins. The repeat units derived from glycidyl methacrylate monomer provide the compatibility for either a homogeneous phase, or a heterogeneous phase with fine dispersion of the copolymer within the thermoplastic matrix which provides improvement in useful physical properties such as the heat deflection temperature, elongation to break and toughness characteristics of these thermoplastics.

The weight fraction of alpha-ML in the copolymer ranges from about 1% to about 99%. Generally, in a composition comprising alpha-ML/GMA copolymer with the thermoplastic PPS, the amount of the alpha-ML/GMA copolymer can be present in an amount of about 1% to about 80% by weight of the blend, preferably from about 10% to about 70%, and more preferably from about 20% to about 40%.

When a coagulant is added to a polymer latex, it is generally believed that the emulsified state is destroyed and that polymer latex particles, which were contained in the polymer latex, agglomerate in large numbers to form primary particles. It has however been difficult to control the sizes of these primary particles. Techniques such as spraying can control the particle size. However, they are unable to form particles larger than about 500 microns (see, for example, U.S. Pat. No. 4,977,241).

The process of the invention provides copolymer particles of controlled size. Controlling the size of the resulting copolymer particles of the invention is accomplished by the addition of ethyl acetate during the coagulation step of the polymerization process. The particle size of the copolymer obtainable by this process can range from about 100 microns to about 5 mm. A preferred particle size is between about 0.5 mm to about 5 mm, and more preferably from about 1 to about 3 mm. The desired size of the particle will depend on the particular desired end-use of the copolymer. For example, a particle size of the copolymer in the range of from about 1 mm to about 2 mm obtained by this process can be useful in mixing with thermoplastic resin pellets which may be a desirable feature for a subsequent intimate blending generally performed by extrusion.

When a coagulant is added to a polymer latex, it is generally believed that the emulsified state is destroyed and that polymer latex particles, which were contained in the polymer latex, agglomerate in large numbers to form primary particles. It has however been difficult to control the sizes of these primary particles. In the process of the invention, the alpha-ML/GMA copolymer emulsion, a coagulant and ethyl acetate are mixed together to coagulate the alpha-ML/GMA copolymer latex. By vigorously agitating the resultant mixture of alpha-ML/GMA latex, such as by stirring, both the sizes of the particles to be formed can be precisely controlled. It is therefore possible to prepare an alpha-MUGMA particulate copolymer that has a narrow particle size distribution and a volume average particle size of several tens of micrometers to several millimeters directly from the alpha-ML/GMA copolymer latex.

The particulate copolymer generated by the addition of ethyl acetate is substantially free of fine particles. In the absence of ethyl acetate, the alpha-ML/GMA particles coagulate as fine powder usually in the size range of 20 microns or less. These fine powders can create problems of contamination in subsequent processing of the polymer, such as during drying in a fluidized bed dryer during processing, or by being airborne during transportation.

In an alternate embodiment of a composition of the invention, the alpha-ML/GMA copolymer can also be a mixture alpha-ML/GMA polymer with varying GMA content in the chain. The range of GMA present in the polymer can be from about 0.5% to about 35%. The GMA content of the polymer can be easily measured by integration of the GMA signals in the proton NMR spectrum in CDCl₃.

Other methods of mixing and blending commonly known in the art can be used. These include compounding extruders, Buss Kneaders, Banbury mixers, roll mills, and the like. The powdered or pelletized resins may be dry-blended, then fed to the processing equipment, or alternatively, the resinous components may be simultaneously fed via a split feeder system. Alternatively, the copolymer emulsion may be fed directly to the extruder with devolatilization of the water.

Another composition of the invention is a polymeric mixture or a blend of the alpha-ML/GMA copolymer of the present invention with polyphenylene sulfide (PPS) polymer. All thermoplastic PPS can be used in the polymeric mixture. PPS used in this invention is a polymer comprising at least 50-mole %, preferably 90-mole % of recurring units represented by the formula (III)

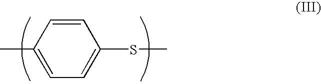

The degree of polymerization of a PPS polymer can be increased by heating the polymer in an oxygen atmosphere or in the presence of a cross-linking agent such as peroxide. The PPS used in the present invention can comprise up to 50-mole % of recurring units represented by any of the following structural formulae:

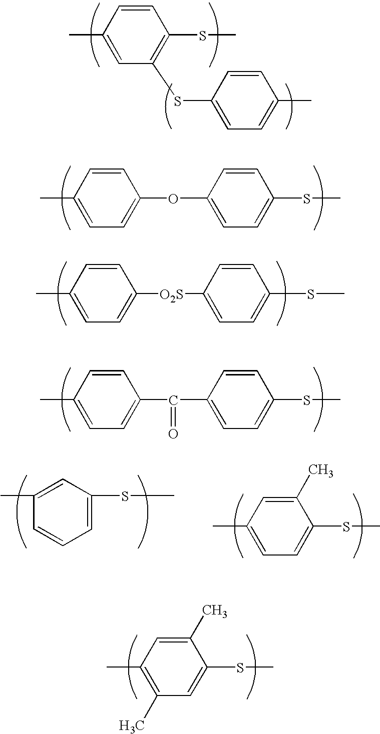

Emulsion polymerization temperatures in the process of the invention can range from 25° C. to about 100° C., preferably from about 60° C. to about 80° C.

Preferred initiators for the polymerization process include thermal type initiator systems. Examples of thermal initiators include organo peroxides, acetyl peroxides, lauroyl peroxide, t-butyl peroxide, di-t-butyl hydroperoxide, peresters, such as t-butyl peroxypivulates; azo-type initiators, such as azo-bis-isobutyrylnitrile; persulfates, such as sodium, potassium, or ammonium persulfate; and peroxyphosphastes, such as sodium, potassium, or ammonium peroxyphosphate.

Preferred initiators for the polymerization process also include redox-type initiator systems. Redox initiators include, for example, a combination of a hydroperoxide, such as hydrogen peroxide, t-butyl hydroperoxide, cumene hydroperoxide, diisopropyl-benzene hydroperoxide, and the like, and a reducing agent, such as sodium, potassium, or ammonium bisulfite, metabisulfite, or hydrosulfite, sulfur dioxide, hydrazine, ferrous salts, isoascorbic acid, and sodium formaldehyde sulfoxalate.

Suitable surfactants for the polymerization process include alkali metal, ammonium salts of alkyl, aryl, alkaryl, ara-alkyl sulfonates, sulfates and polyether sulfates, ethoxylated fatty acids, esters, alcohols, amines, amides, alkyl phenolics, complex organo-phosphoric acids, and their alkali metal and ammonium salts.

Suitable chain transfer agents for the emulsion polymerization process include mercaptans, polymercaptans, and polyhalogen compounds.

Suitable coagulant for the emulsion polymerization process includes magnesium sulfate, sodium chloride and calcium chloride.

All of the compositions herein may optionally include a catalyst to promote the reaction between GMA and PPS. Such grafting catalysts are well known in the art and include, metal salts of hydrocarbon mono-, di- or polycarboxylic acids and metal salts of organic polymers containing carboxyl groups, said cations being selected from the group consisting of Al³⁺, Cd²⁺, Co²⁺, Cu²⁺, Fe²⁺, In³⁺, Mn²⁺, Nd³⁺, Sb³⁺. Such catalysts are described in U.S. Pat. No. 4,912,167 assigned to E. I. du Pont de Nemours and Company, herein incorporated as reference.

All of the compositions herein may additionally comprise other materials commonly found in thermoplastic compositions, such as lubricants, fillers, pigments, ultraviolet light and heat stabilizers, carbon black, nucleating agents, reinforcing agents, short-fiber reinforcement, Kevlar®, Nomex®, dyes, pigments, antioxidants, flame retardants, and antiozonants. The filler material may include glass fibers, carbon fibers, metal fibers, glass beads, asbestos, wollastonite, aluminum silicate, clay, calcium carbonate, talc, and barium sulfate. These may be used alone or in combination.

All of the compositions herein may additionally comprise impact modifiers such as rubber materials including natural or synthetic polymeric materials that are elastic at room temperature. Illustrative of such are natural rubber, butadiene polymer, butadiene-styrene copolymer including random copolymer, block copolymer, graft copolymer and any other structures, isoprene polymer, chlorobutadiene polymer, butadiene-acrylonitrile copolymer, isobutylene polymer, isobutylene-butadiene copolymer, isobutylene-isoprene copolymer, acrylic ester polymer, ethylenepropylene copolymer, ethylenepropylene diene copolymer, Thiokol rubber, polysulfide rubber, polyurethane rubber, polyether rubber such as polypropylene oxide, and epichlorohydrin rubber.

These rubber materials may be prepared by any of known methods, such as emulsion polymerization or solution polymerization, using any of known catalysts such as peroxides, trialkyl aluminum, lithium halide or nickel catalysts. The rubber materials can have various degrees of crosslinking and various ratios between microstructures and cis, trans, and vinyl forms. They may be particles of various generally available sizes. Further, the rubber copolymer may be random copolymer, block copolymers or graft copolymers. The rubber materials may also be copolymers with other monomers such as olefins, dienes, aromatic vinyl compounds, acrylic acid, acrylic esters, and methacrylic ester. These comonomers may be copolymerized in any manner of random copolymerization, block copolymerization or graft copolymerization. Illustrative of these monomers are, for instance, ethylene, propylene, styrene, chlorostyrene, alpha-methyl styrene, butadiene, isoprene, chlorobutadiene, butene, isobutylene, acrylic acid, methyl acrylate, ethyl acrylate, and acrylonitrile.

Specific examples of impact modifiers useful in the present invention include Fusabond® EPDM rubbers, Surlyn® ethylene copolymers, Kratone rubbers, Elvaloye ethylene copolymers, Paraloid® core/shell rubbers, and the like. Other impact modifiers useful in the present invention include ionomers formed from ethylene copolymers (e.g. Surlyn® ethylene copolymers) and ethylene/x-acrylate/glycidyl methacrylate copolymers where x-acrylate can range from methacrylate (1-carbon) to octyl acrylate (8-carbons). These materials may be present in conventional amounts, which vary according to the type(s) of material(s) being added and their purpose in being added, which will be known to persons skilled in the art.

Accordingly it is within the scope of the present invention to provide compositions of the invention wherein the impact modifier is selected from at least one random copolymer, the random copolymer being selected from the group consisting of branched and straight chain polymers, the polymers being derived from the group consisting of:

(a) ethylene;

(b) CO;

(c) unsaturated monomers selected from the class consisting of alpha, beta-ethylenically unsaturated carboxylic acids having from 3 to 8 carbon atoms, and derivatives thereof selected from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;

(d) unsaturated epoxides of 4 to 11 carbon atoms;

(e) residues derived by the loss of nitrogen from an aromatic sulfonyl azide substituted by carboxylic acids taken from the class consisting of monocarboxylic and dicarboxylic acids having from 7 to 12 carbon atoms and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;

(e) unsaturated monomers selected from the class consisting of acrylate esters having from 4 to 22 carbon atoms, vinyl esters of acids having from 1 to 20 carbon atoms, vinyl ethers of 3 to 20 carbon atoms, vinyl and vinylidene halides, and nitriles having from 3 to 6 carbon atoms; and

(g) unsaturated monomers having at least one substituent selected from the group consisting of pendant hydrocarbon chains of 1 to 12 carbon atoms and pendant aromatic groups optionally having 1 to 6 substituent groups having a total of 14 carbon atoms.

### EXAMPLES

In the Examples below, the following abbreviations are used:

GPC—gel permeation chromatography

PD—polydispersity index

MBL—α-methylenebutyrolactone

MeMBL—α-methyl-α-methylenebutyrolactone

MMA—methyl methacrylate

Mn—number average molecular weight

Mw—weight average molecular weight

T_{g}—glass transition temperature (20° C./min. heating rate)

T_{d}—onset of decomposition temperature (20° C./min. heating rate)

NBA—n-butyl acrylate

DOS—sodium dioctylsulfosuccinate surfactant

Alma—allyl methacrylate

K₂S₂O₈—potassium persulfate initiator

EHT—2-ethylhexylthioglycolate chain transfer agent

GMA—glycidyl methacrylate

HEMA—hydroxyethyl methacrylate

EMA—ethyl methacrylate

CHMA—cyclohexyl methacrylate

BMA—butyl methacrylate

MMM—methacrylamide

ManH—maleic anhydride

RI—refractive index

EDTA—ethylene diamine tetracetic acid

EBAGMA—Ethylene-n-butyl acrylate-glycidyl methacrylate copolymer

PPS—Polyphenylene Sulfide

### General Method

Step 1: Polymer Synthesis

The following ingredients were mixed in specified amounts, in a 2 L flask at room temperature using a magnetic stir bar for agitation:

| Material | Weight (g) |
|---|---|
| MeMBL | 322 |
| Dioctylsulfosuccinate | 3.5 |
| glycidyl methacrylate | 28 |
| ethylhexyl thioglycolate | 10.5 |
| water to emulsify | 350 |
| monomers | |

In the next step, 1.7 L water was charged to a 5 L Morton flask equipped with a condenser, mechanical stirrer, a nitrogen sparger. The water was heated to about 80° C. and was sparged with nitrogen as it heated. Once the water in the flask had reached about 80° C., it was held at that temperature for about 10 min. Subsequently, 10% content by weight of the pre-emulsified mixture of monomer MeMBL, prepared previously, was added to the flask. Potassium persulfate (0.7 g dissolved in 50-mL water) was added to the reaction mixture, all at once. The remainder of the pre-emulsified mixture of monomer MeMBL, prepared previously, was added to the reaction mixture in the Morton flask, over a span of 30 min., accompanied by stirring of the reaction mixture Thereafter, the reaction mixture was stirred for two hours while held at the same temperature of about 80° C. Polymeric emulsion was formed as a result.

Step 2: Coagulation

The polymer emulsion from the reaction mixture in step 1 was cooled to 30° C. In the next step, 20 g of MgSO₄ dissolved in 200-mL water was added to the polymer emulsion by means of an addition funnel over a span of 5 min. This coagulated the emulsion to give fine particles of MeMBL-GMA copolymer. Subsequently, ethyl acetate was added at room temperature to the emulsion by means of an addition funnel until the polymer became granular or formed bead shaped agglomerates. The amount of ethyl acetate to be added varied with the content of glycidyl methacrylate added in step 1, however the general range of addition was of about 500 mL. The contents in the flask were stirred for about 10 to 15 min.

In the next step, the coagulate, inclusive of the polymer granules, was filtered at room temperature. The coagulate was subsequently washed with water and allowed to air dry on a fritted glass funnel for 24 hours. A constant sweep of nitrogen and house vacuum was adequate to remove the majority of the moisture. Following the vacuum drying step, the polymeric material was oven dried at about 70° C. for 24 hours to remove residual moisture. The moisture content of the polymer was typically less than about 1%.

Step 3: Polymer Blending

Standard procedures were used for blending. In a typical procedure, the thermoplastic polymer pellets were mixed with the methylene lactone-based polymer in a polyethylene bag. The contents of the bag were placed in the hopper of the extruder and fed into the extruder barrel via screw feeders. If the extruder was equipped with multiple feed positions, the thermoplastic polymer polyphenylene sulfide was fed simultaneously with methylene lactone-based polymer.

Used were the preferred PPSgrades, Ryton® PR34, GR02, and PR09, all of which were obtained from Chevron-Phillips Chemical Co., Bartlesville, Okla. Ethylene/methyl acrylate/n-butyl acrylate/zinc elastomer for toughening PPS as various grades of Surlyn®, and an ethylene/propylene polymer containing maleic anhydride grafts as Fusabond®493D were obtained from E. I. du Pont de Nemours and Co., Wilmington, Del.

The copolymers of the comparative examples or the MeMBL/GMA copolymer, PPS, and optionally the impact modifier/s Surlyn® and/or Fusabond® MN493D were blended and subsequently compounded in either a 16 mm twin screw Prism® extruder or a 30 mm twin screw Werner Pfielder® twin screw extruder.

### EXAMPLES 1-4

In Example 1, 80% by weight of high molecular weight Ryton® PPS was blended with 20% by weight of MeMBL/GMA copolymer wherein the copolymer contained 4% GMA.

In Example 2, 65% by weight of high molecular weight Ryton® PPS was blended with 20% by weight of MeMBL/GMA copolymer wherein the copolymer contained 4% GMA, and 15% of EBAGMA containing 5% by weight of GMA.

In Example 3, 70% by weight of Ryton® PR34 PPS with Surlyn® and EBAGMA (in a blend) impact modifiers, was blended with 30% by weight of MeMBL/GMA copolymer wherein the copolymer contained 4% GMA.

In Example 4, 100% of high molecular weight Ryton® PPS was used as a baseline study.

Samples were molded on a 1.5 oz. injection-molding machine at 280° C.

| | Examples | | | |
|---|---|---|---|---|
| | 1 | 2 | 3 | 4 |
| | Parts | Parts | Parts | Parts |
| High MW Ryton ® PPS | 80 | 65 | 0 | 100 |
| homopolymer | | | | |
| PPS/Surlyn ®/Ebagma blend | 0 | 0 | 70 | 0 |
| (65% Ryton ®PR34, 28.2% | | | | |
| Ebagma, 5.6% Surlyn ®9320, | | | | |
| 1.2% Irganox ® 1010) | | | | |
| 4% GMA/MeMBL copolymer | 20 | 20 | 30 | 0 |
| Ebagma 5% GMA | 0 | 15 | 0 | 0 |
| Total Parts | 100.00 | 100.00 | 100.00 | 100.00 |
| Physical Property | | | | |
| (dry; as molded) | | | | |
| HDT @ 0.45 MPa (° C.) | 175 | 158 | 170 | 151 |
| HDT @ 1.82 MPa (° C.) | 126 | 99 | 121 | 109 |
| Elongation at Break (%) 0.5 | 1.48 | 2.21 | 0.93 | 2.76 |
| cm/min | | | | |
| Tensile Strength at Break (MPa) | 57.6 | 34.3 | 23.4 | 79.5 |
| Flex Modulus (MPa) | 2866 | 2391 | 1867 | 3548 |
| Notched Izod (J/m) | 13.75 | 59.9 | 56.1 | 27.5 |

1. A copolymer composition comprising:
(a) at least one polymeric repeat unit represented by formula I derived from alpha-methylene lactone monomer,
(b) at least one polymeric repeat unit represented by formula II derived from glycidyl methacrylate monomer, wherein said polymeric repeat unit represented by formula II comprises from about 0.5% to about 45% by weight of the copolymer composition;
(c) polyphenylene sulfide according to formula (III), and
(d) optionally, one or more impact modifier in the range from 0.5% to 35% by total weight of all compounds, 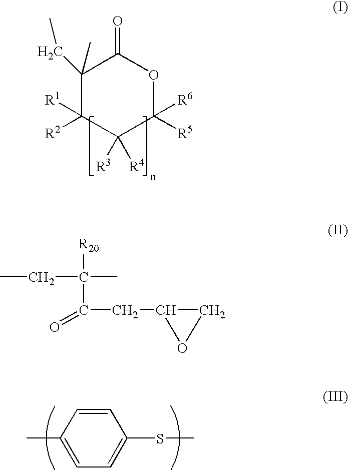
wherein: n is 0, 1 or 2;
R¹, R², R³, R⁴, R⁵, R⁶, and R₂₀ are independently hydrogen, a functional group, hydrocarbyl or substituted hydrocarbyl,

2. The composition as recited in claim 1 wherein when n=0; R¹, R², and R⁵ are independently hydrogen, and R⁶ is methyl.

3. The composition as recited in claim 1 or claim 2 wherein the glycidyl methacrylate content is from about 0.5% to about 35% of the total composition.

4. The composition as recited in claim 1, wherein the impact modifier is selected from at least one random copolymer, the random copolymer being selected from the group consisting of branched and straight chain polymers, the polymers being derived from the group consisting of:
(a) ethylene;
(b) CO;
(c) unsaturated monomers selected from the class consisting of alpha, beta-ethylenically unsaturated carboxylic acids having from 3 to 8 carbon atoms, and derivatives thereof selected from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;
(d) unsaturated epoxides of 4 to 11 carbon atoms;
(e) residues derived by the loss of nitrogen from an aromatic sulfonyl azide substituted by carboxylic acids taken from the class consisting of monocarboxylic and dicarboxylic acids having from 7 to 12 carbon atoms and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;
(f) unsaturated monomers selected from the class consisting of acrylate esters having from 4 to 22 carbon atoms, vinyl esters of acids having from 1 to 20 carbon atoms, vinyl ethers of 3 to 20 carbon atoms, vinyl and vinylidene halides, and nitrites having from 3 to 6 carbon atoms; and
(g) unsaturated monomers having at least one substituent selected from the group consisting of pendant hydrocarbon chains of 1 to 12 carbon atoms and pendant aromatic groups optionally having 1 to 6 substituent groups having a total of 14 carbon atoms.

5. A composition according to claim 1 wherein the polyphenylene sulfide according to formula (III) is selected from the group consisting of:

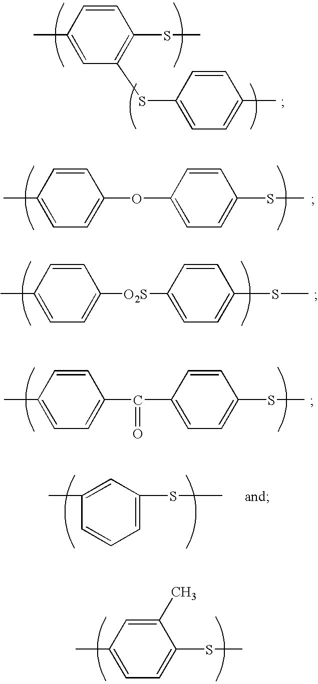

6. A method for preparing a copolymer composition, the method comprising the steps of:
(a) contacting at least one alpha methylene lactone monomer of formula (I) with a glycidyl methacrylate monomer of general formula (II), in an aqueous medium,
(b) optionally, contacting the product of step (a) with a chain-transfer agent and a surfactant,
(c) contacting the product of step (a) or step (b) with an initiator,
(d) contacting the product of step (c) with a coagulant, to obtain the copolymer composition,
(e) optionally, contacting the product of step (d) with ethyl acetate,
(f) optionally, agitating the product of step (e),
(g) optionally, filtering the copolymer composition, and
(e) optionally, drying the copolymer composition.

7. The method of claim 6 wherein the alpha methylene lactone monomer is 5-methyl-alpha-methylene-gamma-butyrolactone.

8. The method of claim 7 wherein the chain transfer agent is 2-ethylhexylthioglycolate, the surfactant is dioctylsulfosuccinate, the initiator is potassium persulfate, and the coagulant is MgSO₄.

9. The method of claim 6 wherein the chain transfer agent is selected from mercaptans, polymercaptans, and polyhalogen compounds.

10. The method of claim 6 wherein the surfactant is selected from alkali metal and ammonium salts of alkyl, aryl, alkaryl, and ara-alkyl sulfonates, sulfates, and polyether sulfates, ethoxylated fatty acids, esters, alcohols, amines, amides, alkyl phenols, complex organo-phosphoric acids, and their alkali metal and ammonium salts

11. The method of claim 6 wherein the initiator is selected from the group consisting of thermal initiators, azo-type initiators, persulfates, peroxysulfates, and redox-type initiators, wherein the thermal initiators are selected from the group consisting of organo peroxides, acetyl peroxides, lauroyl peroxide, t-butyl peroxide, di-t-butyl hydroperoxide, and peresters; and the redox-type initiators are selected from the group consisting of hydroperoxide being selected from the group consisting of hydrogen peroxide, t-butyl hydroperoxide, cumene hydroperoxide, and diisopropyl-benzene hydroperoxide, and a reducing agent being selected from the group consisting of sodium, potassium, or ammonium bisulfite, metabisulfite, hydrosulfite, sulfur dioxide, hydrazine, ferrous salts, isoascorbic acid, and sodium formaldehyde sulfoxalate.

12. The method of claim 6 wherein the coagulant is selected from magnesium sulfate, sodium chloride, calcium chloride.

13. A shaped, molded or extruded article comprising the copolymer composition of claim 1.
